(19) United States
(12) Patent Application Publication
(10) Pub. No.: US 2014/0222564 A1
(43) Pub. Date: Aug. 7, 2014

(54) GEO-LOCATED SOCIAL CONNECTIVITY RELATING TO EVENTS AND COMMERCE

(71) Applicant: KBR IP Holdings, LLC, Provo, UT (US)

(72) Inventors: Nathaniel Brent Kranendonk, Springville, UT (US); Brett Leon Ross, Salt Lake City, UT (US); David O. Hyde, American Fork, UT (US); Lukas Olson, Gilbert, AZ (US)

(73) Assignee: KBR IP Holdings, LLC, Provo, UT (US)

(21) Appl. No.: 14/173,343

(22) Filed: Feb. 5, 2014

Related U.S. Application Data
(60) Provisional application No. 61/761,884, filed on Feb. 7, 2013.

(51) Int. Cl. G06Q 50/00; G06Q 30/02

(52) U.S. Cl. CPC G06Q 50/01; G06Q 30/0255
USPC 705/14.53

(57) ABSTRACT

The present invention extends to methods, systems, and computer program products for geo-located social connectivity relating to people, events, and commerce. In general, embodiments of the invention provide a social commerce matching system. An intelligent interactive tool provides individuals the ability to geo-locate like-minded individuals/groups and participate in events. Individuals or businesses can generate events. Businesses can support events through advertising promotions, and deals.

### CROSS-REFERENCE TO RELATED APPLICATIONS

This application claims the benefit of and priority to U.S. Provisional Patent Application Ser. No. 61/761,884, entitled “Geo-Located Social Connectivity Relating To Events And Commerce”, filed Feb. 7, 2013 by Nathaniel Brent Kranendonk et al., the entire contents of which are expressly incorporated by reference.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

For example, computer networks are frequently used for social networking. Multiple users can access social networking Web sites on the Internet to share information with one another, play games, access news, view deals, schedule meetings, etc. However, most, if not all, social networking sites target a single or limited subset of social networking functionalities. Some sites exist to bring people together to converse, post ideas, interact in forums and share life memories through pictures, etc. (i.e., provide social functionality). Other sites exist to schedule meetings, events and special occasions (i.e., provide event functionality). Even more sites exist that target potential end users of ads, promotions and deals (i.e., provide deal functionality).

Further, most, it not all, social media lacks the ability to group similar like-minded individuals in an actionable, real-world event with commerce/retail opportunities targeted to the group based on past behavior and purchase patterns.

### BRIEF SUMMARY

The present invention extends to methods, systems, and computer program products for geo-located social connectivity relating to people, events, and commerce. In general, embodiments of the invention provide a social commerce matching system. An intelligent interactive tool provides individuals the ability to geo-locate like-minded individuals/groups and participate in events. Individuals or businesses can generate events. Businesses can support events through advertising promotions, and deals.

In some embodiments, a person is matched to an activity. An activity can be an event or deal. User profile information for a person is accessed. The user profile information for the person includes interests, geographic location, and geo-location settings for the person. The geo-location settings indicate a specified distance from the person. The person desires to be made aware activities of interest that are within the specified distance of the geographic location of the person.

Activity profile information is accessed for one or more activities. The activity profile information includes an activity subject and geographic location for each of the one or more activities. An activity, from among the one or more activities, is identified as being relevant to the person. The identified activity is identified as being relevant to the person based on the activity being of interest to the person and the geographic location of the activity being within the specified distance of the geographic location of the person.

In other embodiments one person is matched to another person. User profile information for a person is accessed. The user profile information for the person includes interests, geographic location, and geo-location settings for the person. The geo-location settings indicate a specified distance from the person. The person desires to be made aware other people of interest that are within the specified distance of the geographic location of the person.

Further user profile information for one or more other people is accessed. The further user profile information includes a geographic location for each of the one or more other people. Another person, from among the one or more people, is identified as being relevant to the person. The identified other person is identified as being relevant to the person based on the other person being of interest to the person and the location of the other person being within the specified distance of the geographic location of the person.

In further embodiments, a marketing activity is assigned to an event. A marketing activity can include one or more of a deal, an advertisement, and a promo. It is detected that a user of a social network has created an event. Event profile information is accessed for the event. The event profile information includes an event subject, a geographic location, and geo-location settings associated with the event. The geo-location settings indicate a specified distance from the event. The user desires for marketing activities relevant to the event and that are within the specified distance of the geographic location of the event to be assigned to the event.

Marketing profile information is accessed for one or more marketing activities. The marketing profile information includes a marketing subject and a geographic location for each of the one or more marketing activities. A marketing activity, from among the one or more marketing activities, is identified as relevant to the event. The identified marketing activity identified as being relevant to the event based on the marketing subject being relevant to the event subject and the geographic location of the marketing activity being with the specified distance of the event.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates geo-located social connectivity relating to people and activities.

FIG. 2 illustrates a flow chart of an example method for matching a person to an activity.

FIG. 3 illustrates an example computer architecture that facilitates geo-located social connectivity relating to people.

FIG. 4 illustrates a flow chart of an example method for matching a person to another person.

FIG. 5 illustrates an example computer architecture that facilitates geo-located social connectivity relating to event activities and marketing activities.

FIG. 6 illustrates a flow chart of an example method for assigning a marketing activity to an event activity.

FIG. 7 illustrates another example computer architecture that facilitates geo-located social connectivity relating to people, events, and commerce.

### DETAILED DESCRIPTION

The present invention extends to methods, systems, and computer program products for geo-located social connectivity relating to people, events, and commerce. In general, embodiments of the invention provide a social commerce matching system. An intelligent interactive tool provides individuals the ability to geo-locate like-minded individuals/groups and participate in events. Individuals or businesses can generate events. Businesses can support events through advertising promotions, and deals.

In some embodiments, a person is matched to an activity. An activity can be an event or deal. User profile information for a person is accessed. The user profile information for the person includes interests, geographic location, and geo-location settings for the person. The geo-location settings indicate a specified distance from the person. The person desires to be made aware activities of interest that are within the specified distance of the geographic location of the person.

Activity profile information is accessed for one or more activities. The activity profile information includes an activity subject and geographic location for each of the one or more activities. An activity, from among the one or more activities, is identified as being relevant to the person. The identified activity is identified as being relevant to the person based on the activity being of interest to the person and the geographic location of the activity being within the specified distance of the geographic location of the person.

In other embodiments one person is matched to another person. User profile information for a person is accessed. The user profile information for the person includes interests, geographic location, and geo-location settings for the person. The geo-location settings indicate a specified distance from the person. The person desires to be made aware other people of interest that are within the specified distance of the geographic location of the person.

Further user profile information for one or more other people is accessed. The further user profile information includes a geographic location for each of the one or more other people. Another person, from among the one or more people, is identified as being relevant to the person. The identified other person is identified as being relevant to the person based on the other person being of interest to the person and the location of the other person being within the specified distance of the geographic location of the person.

In further embodiments, a marketing activity is assigned to an event. A marketing activity can include one or more of a deal, an advertisement, and a promo. It is detected that a user of a social network has created an event. Event profile information is accessed for the event. The event profile information includes an event subject, a geographic location, and geo-location settings associated with the event. The geo-location settings indicate a specified distance from the event. The user desires for marketing activities relevant to the event and that are within the specified distance of the geographic location of the event to be assigned to the event.

Marketing profile information is accessed for one or more marketing activities. The marketing profile information includes a marketing subject and a geographic location for each of the one or more marketing activities. A marketing activity, from among the one or more marketing activities, is identified as relevant to the event. The identified marketing activity identified as being relevant to the event based on the marketing subject being relevant to the event subject and the geographic location of the marketing activity being with the specified distance of the event.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. More specifically, embodiments of the invention can be implemented as an application (“app”) on a mobile device, such as, for example, a mobile telephone. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

Embodiments of the invention provide intelligent interactive tools for individuals to geo-locate like-minded individuals/groups, participate in events (self-generated or by others/businesses), with local and national businesses supporting the events through advertising promotions, and deals.

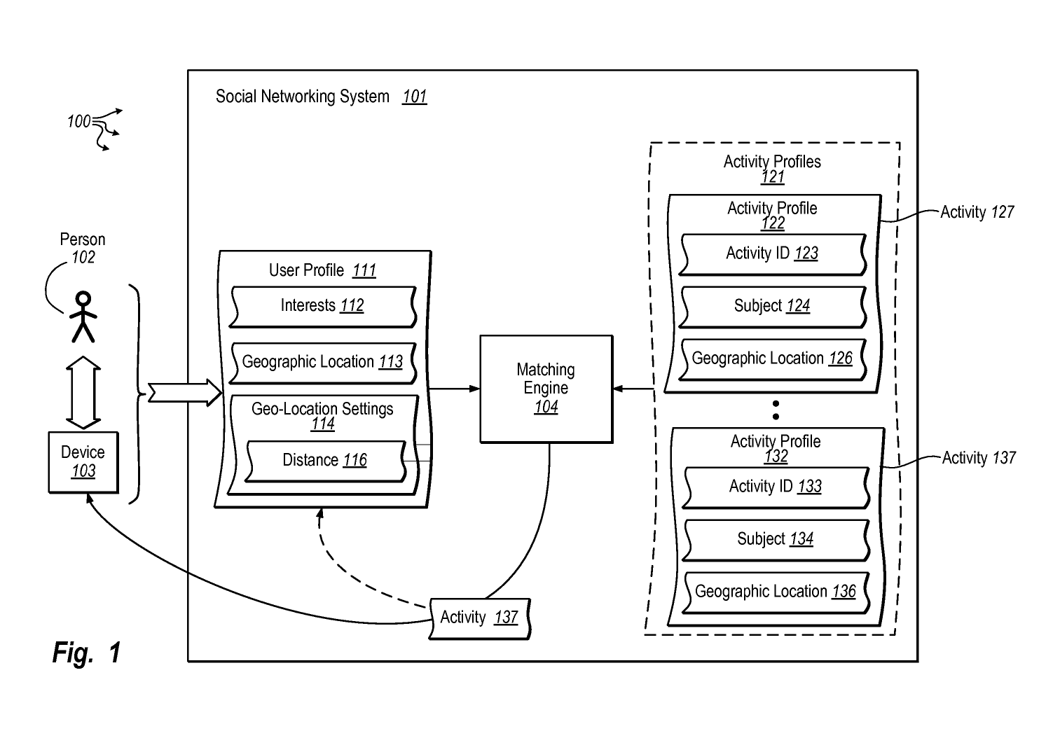

FIG. 1 illustrates an example computer architecture 100 that facilitates geo-located social connectivity relating to people and activities. Referring to FIG. 1, computer architecture 100 includes social networking system 101 and device 103. Each of social networking system 101 and device 103 can be connected to one another over (or be part of) a network, such as, for example, a Local Area Network (“LAN”), a Wide Area Network (“WAN”), and even the Internet. Accordingly, social networking system 101 and device 103 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

Social networking system 101 includes matching engine 104. Matching engine 104 can be used to match a person to an activity, such as, for example, an event or deal. Matching can be facilitated by one or more of: geographic location, geo-location setting, and user interests.

Person 102 can use device 103 to connect to social networking system 101. For example, person 102 can be a user of social networking system 101. Accordingly, person 102 can create and maintain a user profile (e.g., user profile 111) on social networking system 101. Other users of social networking system 101 can also create and maintain corresponding user profiles. A user profile can contain elements representing essentially any information about a user, such as, for example, the user's interests, the user's geographic location, the user's geo-location settings, the user's age, the user's gender, the user's sexual orientation, the user's religion, the user's race, the user's school, etc. Social networking system 101 can have hundreds, thousands, or even millions of users and thus hundreds, thousands, or even millions of corresponding user profiles.

Geo-location settings can include a specified distance. The user may desire to be made aware of activities that are closer than the specified distance to the user. The user may desire to not be made aware of activities that are further than the specified distance from the user. In some embodiments, a specified distance is a radius around the user, such as, for example, 100 yds, a ½ mile, a mile, etc. A user may desire to be made aware of activities with the radius. In other embodiments, the specified distance can represent a general geographic area, such as, for example, a zip code. The zip code may or may not be where the user is geographically located. For example, if concerts are frequently held within a zip code, a user may desire to be made aware of activities in the zip code even when the user is not physically present within the zip code.

A user's device (e.g., device 103) can update a geographic location for the user (person 302) as the user moves. For example, a mobile phone can use Global Positioning System (“GPS”) coordinates to determine a user's location and automatically update the user's profile with the user's geographic location.

Users can also publicize activities. For example, a user can create information about an activity on social networking site 101, such as, for example, an activity profile, to make other users aware an activity. An activity can be an event (e.g., concerts, conventions, public events, sporting event, etc.) or deal (e.g., advertisements, coupons, promotions, etc.). An activity profile can include an activity identifier (e.g., a name), an activity subject or topic (which can be used to align with users' interests), a geographic location, a date, a time, an activity description, etc.

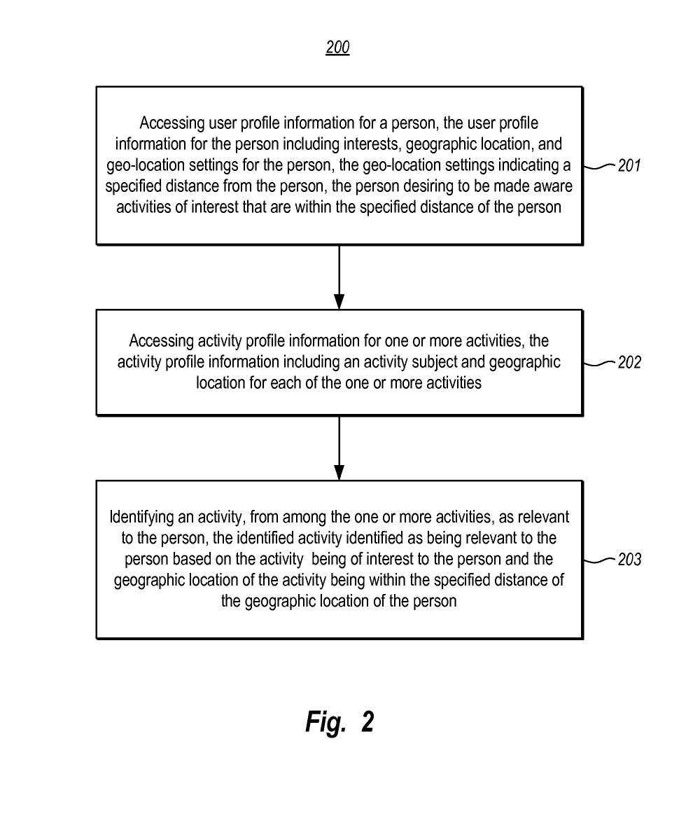

FIG. 2 illustrates a flow chart of an example method 200 for matching a person to an activity. Method 200 will be described with respect to the components and data of computer architecture 100.

Method 200 includes accessing user profile information for the person, the user profile information for the person including interests, geographic location, and geo-location settings for the person, the geo-location settings indicating a specified distance from the person, the person desiring to be made aware activities of interest that are within the specified distance of the person (201). For example, matching engine 104 can access user profile 111 (a user profile for person 102). As depicted, user profile 111 includes interests 112, geographic location 113, and geo-location settings 114. Geo-location settings 114 further include distance 116. Based on the information in user profile 111, matching engine 104 can determine that person 102 desires to be made aware of activities within distance 116 of geographic location 113 and that are relevant to interests 112. Interests 112 can be previously indicated through an interface to social networking system 101. Interests 112 can include various different interests, such as, for example, music, movies, technology, meeting other people, politics, sports, etc.

Method 200 includes accessing activity profile information for one or more activities, the activity profile information including an activity subject and geographic location for each of the one or more activities (202). For example, matching engine 104 can access activity profiles 121. Activity profiles 121 can include activity profiles for a plurality of different events. As depicted, activity profiles 121 include activity profile 122 for activity 127, activity profile 132 for activity 137, etc.

Each activity profile in activity profiles 121 can include an activity ID (e.g., an activity name), an activity subject, and a geographic location. For example, activity profile 122 and activity profile 132 include activity IDs 123 and 133 respectively, subjects 123 and 124 respectively, and geographic locations 126 and 136 respectively. When an activity is of limited duration, an activity profile can also include a date and time when the activity is to occur or is occurring.

Method 200 include identifying an activity, from among the one or more activities, as relevant to the person, the identified activity identified as being relevant to the person based on the activity being of interest to the person and the geographic location of the activity being within the specified distance of the geographic location of the person (203). For example, matching engine 104 can identify activity 137 as being relevant to person 102 (based on the content of user profile 111). Matching engine 104 can identify activity 137, based on interests 112 and subject 134 having sufficient similarity and geographical location 136 being within distance 116 of geographical location 113.

Upon identifying activity 137, matching engine 104 can send activity 137 to device 103 and/or store activity 137 in user profile 111 for output to person 102.

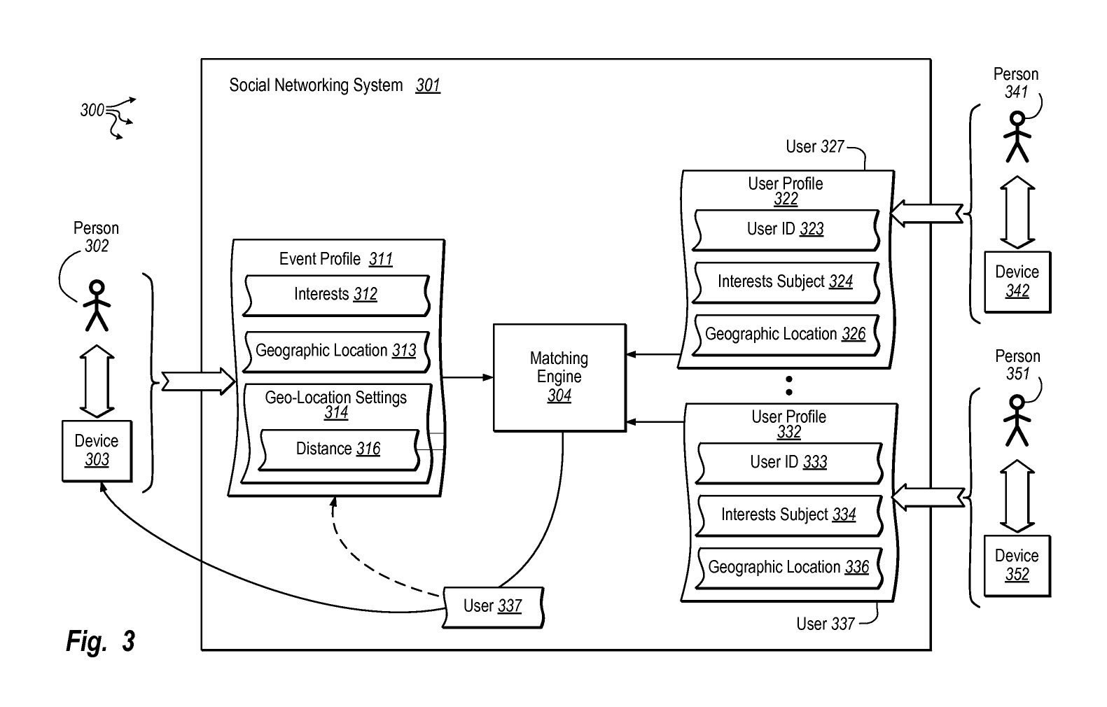

FIG. 3 illustrates an example computer architecture 300 that facilitates geo-located social connectivity relating to people. Referring to FIG. 3, computer architecture 300 includes social networking system 301 and devices 303, 342, and 352. Each of social networking system 301 and devices 303, 342, and 352 can be connected to one another over (or be part of) a network, such as, for example, a Local Area Network (“LAN”), a Wide Area Network (“WAN”), and even the Internet. Accordingly, social networking system 301 and devices 303, 342, and 352 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

Social networking system 301 includes matching engine 304. Matching engine 304 can be used to match a person to other likeminded people. Matching can be facilitated by profile elements including one or more of: geographic location, geo-location setting, and user interests. Matching engine 304 can also include filters that filter out other people specifically indicated not to be of interest to a user, such as, for example, based on user profile elements indicating age, gender, sexual orientation, religion, race, etc.

Users can use computing devices to connect to social networking system 301. For example, people 302, 341, and 351 can use devices 303, 342, and 352 respectively to connect to social networking system 301. Each of persons 302, 341, and 351 can be a user of social networking system 301. Each person that uses social networking system 301 can have a user profile. As such, each of persons 302, 341, and 351 can create and maintain user profiles 311, 322, and 332 respectively on social networking system 301. Other users of social networking system 301 can also create and maintain corresponding user profiles. As described, a user profile can contain elements representing essentially any information about a user, such as, for example, the user's interests, the user's geographic location, the user's geo-location settings, user's age, the user's gender, the user's sexual orientation, the user's religion, the user's race, the user's school, etc. Social networking system 301 can have hundreds, thousands, or even millions of user and thus hundreds, thousands, or even millions of corresponding user profiles.

Also as described, a user's device (e.g., device 301, 342, 352) can update a geographic location for the user (e.g., person 302 341, 351) as the user moves. For example, a mobile phone can use Global Positioning System (“GPS”) coordinates to determine a user's location and automatically update the user's profile with the user's geographic location.

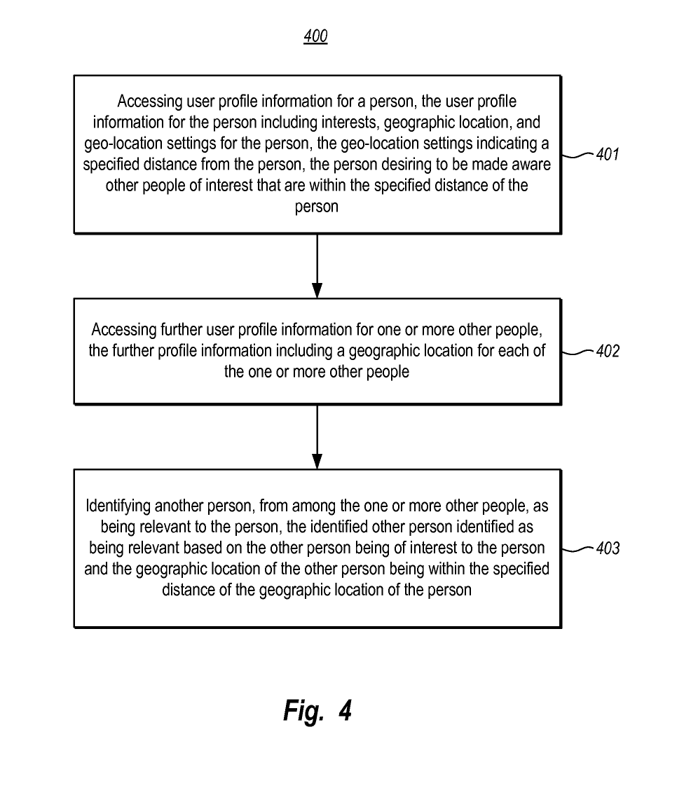

FIG. 4 illustrates a flow chart of an example method 400 for matching a person to another person. Method 400 will be described with respect to the components and data of computer architecture 300.

Method 400 includes accessing user profile information for the person, the user profile information for the person including interests, geographic location, and geo-location settings for the person, the geo-location settings indicating a specified distance from the person, the person desiring to be made aware other people of interest that are within the specified distance of the person (401). For example, matching engine 304 can access user profile 311 (a user profile for person 302). As depicted, user profile 311 includes interests 312, geographic location 313, and geo-location settings 314. Geo-location settings 314 further include distance 316. Based on the information in user profile 311, matching engine 304 can determine that person 302 desires to be made aware of other persons within distance 316 of geographic location 313 and that are relevant to interests 312. Interests 312 can be previously indicated through an interface to social networking system 301. Interests 312 can include various different interests, such as, for example, music, movies, technology, politics, sports, etc.

Method 400 includes accessing further user profile information for one or more other people, the further profile information including a geographic location for each of the one or more other people (402). For example, matching engine 304 can access user profiles 322, 332, etc. for persons 342, 351, etc. Each user profile can correspond to a user that in turn corresponds to a person. For example, user profile 322 is for user 327 which corresponds to person 341. Similarly, user profile 332 is for user 337 which corresponds to person 351.

Each user profile can include a user ID (e.g., a user name), the user's interests, and the user's (e.g., last know) geographic location. For example, user profile 322 indicates user ID 323, interests 324, and geographic location 326 for user 327 (i.e., person 341). Similarly, user profile 332 indicates user ID 333, interests 334, and geographic location 336 for user 327 (i.e., person 341)

Method 400 includes identifying another person, from among the one or more other people, as being relevant to the person, the identified other person identified as being relevant based on the other person being of interest to the person and the geographic location of the other person being within the specified distance of the geographic location of the person (403). For example, matching engine 304 can identify user 337 (person 351) as being relevant to person 302 (based on the content of user profiles 311 and 332). Matching engine 304 can identify user 337, based on interests 312 and interests 334 having sufficient similarity and geographical location 336 being within distance 316 of geographical location 313. Other users can also be identified in a similar manner.

Upon identifying user 337 (and other any other users), matching engine 304 can send user 337 (and other any other users) to device 303 and/or store activity 337 in user profile 311 for output to person 302.

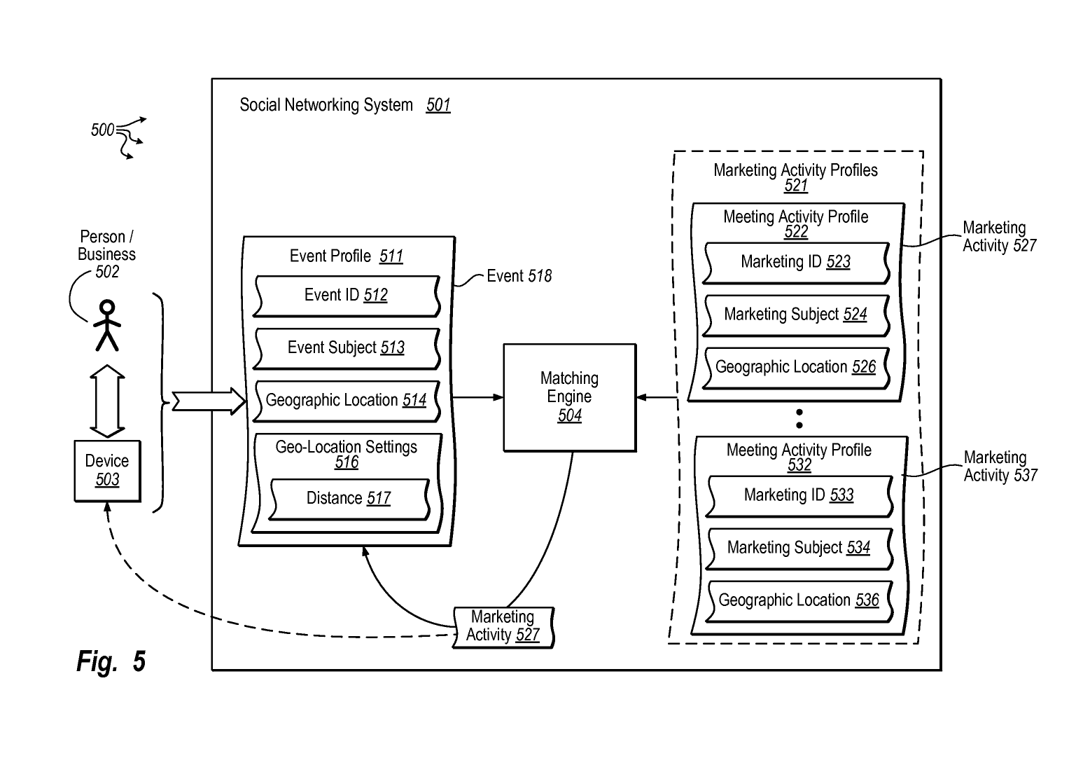

FIG. 5 illustrates an example computer architecture 500 that facilitates geo-located social connectivity relating to event activities and marketing activities. Referring to FIG. 5, computer architecture 500 includes social networking system 501 and device 503. Each of social networking system 501 and device 503 can be connected to one another over (or be part of) a network, such as, for example, a Local Area Network (“LAN”), a Wide Area Network (“WAN”), and even the Internet. Accordingly, social networking system 501 and device 503 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

Social networking system 501 includes matching engine 504. Matching engine 504 can be used to match an event activity to a marketing activity. Matching can be facilitated by one or more of: geographic location, geo-location setting, an event subject (e.g., a sporting event, for example, a game, a convert, a movie, etc.), and a marketing subject (e.g., a discount on musical instruments, an advertisement for a next sporting event, for example, the next game, etc.)

Users of social networking system 501 can create and maintain profiles for event activities and marketing activities. Social networking system 501 can have hundreds, thousands, or even millions of users. Users can use computing devices to connect to social networking system 501. For example, person/business 502 can use device 503 to connect to social networking system 501. Person/business 502 can be a user of social networking system 501. Other users (now shown) can also use other computing devices (not shown) to connect to social networking system 501.

Users of social networking system 501 can create and publicize information about event activities on social networking site 501, such as, for example, in an event profile. An event activity can be, for example, a concert, a convention, a political event, a sporting event, etc. An event profile can include an event identifier (e.g., a name), an event subject or topic (which can be used to align with marketing activity subjects or topics), a geographic location, a date, a time, an event description, etc.

A person's/business' device (e.g., 503) can update a geographic location for an event activity as the event moves (e.g., a race or parade). For example, a mobile phone can use Global Positioning System (“GPS”) coordinates to determine an event activity's location and automatically update the event's profile with the event's geographic location.

Users of social networking system 501 can also create and publicize information about marketing activities on social networking site 501, such as, for example, in an marketing activity profile. A marketing activity can be, for example, deals, advertisements, coupons, promotions, etc. A marketing activity profile can include a marketing identifier (e.g., a name), a marketing subject or topic (which can be used to align with event activity subjects or topics), a geographic location, a date, a time, a marketing activity description, etc.

A person's/business' device can update a geographic location for a marketing activity as the marketing activity moves (e.g., mobile food truck, delivery truck, radio station personality, etc.). For example, a mobile phone can use Global Positioning System (“GPS”) coordinates to determine marketing activity's location and automatically update the marketing activity's profile with the marketing activity's geographic location.

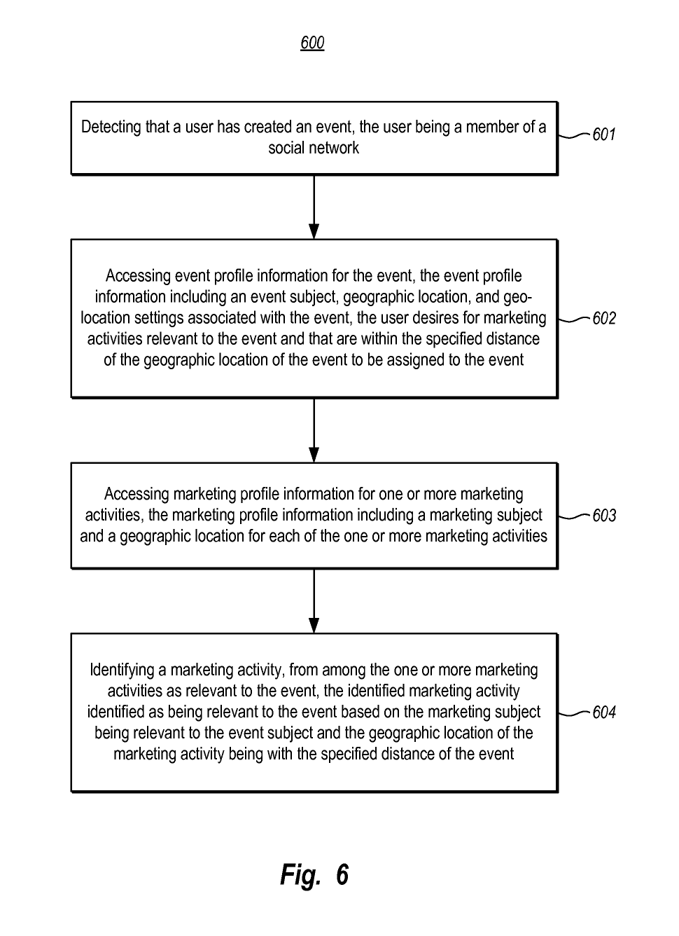

FIG. 6 illustrates a flow chart of an example method 600 for assigning a marketing activity to an event activity. Method 600 will be described with respect to the components and data of computer architecture 500.

Method 600 includes detecting that a user has created an event, the user being a member of a social network (601). For example, matching engine 504 can detect the creation event profile 511 by person/business 502. Event profile 511 can be an event profile for event 518.

Method 600 includes accessing event profile information for the event, the event profile information including an event subject, geographic location, and geo-location settings associated with the event, the user desires for marketing activities relevant to the event and that are within the specified distance of the geographic location of the event to be assigned to the event (602). For example, matching engine 504 can accessing event subject 513, geographic location 514, and geo-location settings 516 from event profile 511. Geo-location settings 516 include distance 517. Person/business 502 may desire to be made aware of marketing activities relevant to event 518 that are within distance 517 of geographic 514.

Method 600 includes accessing marketing profile information for one or more marketing activities, the marketing profile information including a marketing subject and a geographic location for each of the one or more marketing activities (603). For example, matching engine 504 can access marketing activity profiles 521. Marketing profiles 521 can include marketing activity profiles for a plurality of different marketing activities. As depicted, marketing activity profiles 521 include marketing activity profile 522 for marketing activity 527, marketing activity profile 532 for marketing activity 537, etc.

Each marketing activity profile in marketing activity profiles 521 can include a marketing ID (e.g., a marketing activity name), an marketing subject, and a geographic location. For example, marketing activity profile 522 and marketing activity profile 532 include marketing IDs 523 and 533 respectively, marketing subjects 523 and 524 respectively, and geographic locations 526 and 536 respectively. When an marketing activity is of limited duration, a marketing activity profile can also include a date and time when the marketing activity is to occur or is occurring.

Method 600 includes identifying a marketing activity, from among the one or more marketing activities as relevant to the event, the identified marketing activity identified as being relevant to the event based on the marketing subject being relevant to the event subject and the geographic location of the marketing activity being with the specified distance of the event (604). For example, matching engine 504 can identify marketing activity 527 as being relevant to event 518 (based on the content of event profile 111). Matching engine 504 can identify activity 527, based on subject 513 and subject marketing subject 524 having sufficient similarity and geographical location 526 being within distance 517 of geographical location 514. For example, matching engine 504 might identify a sale of t-shirts for a musical group near a concert where the musical group is performing.

Upon identifying marketing activity 527, matching engine 504 can send marketing activity 527 to event profile 511 and/or device 503 for output to person/business 502.

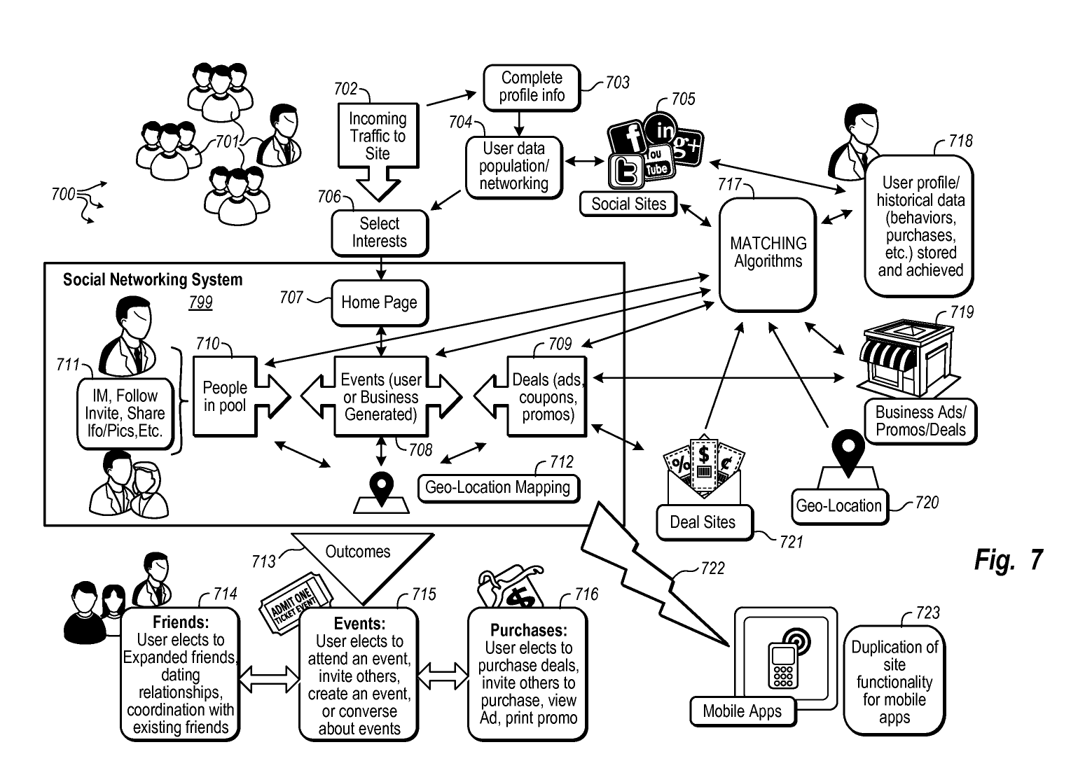

FIG. 7 illustrates another example computer architecture 700 that facilitates geo-located social connectivity relating to people, events, and commerce.

Incoming traffic 702 for users 701 (whether individuals or business representatives) can enter social networking site 799 through a network, such as, for example, the World Wide Web (“WWW”) or other Internet access. New users can be prompted to complete profile information 703 and have the option 704 to populate their profile information by using log-in information from other social network sites 705. Social networking system 799 is configured to pull profile information from other social network sites 705 in order to populate appropriate data in a profile for social networking system 799. Social networking system 799 can also mine social network sites 705 to access other demographic information, behaviors, etc. for a user.

When profile information is populated, a user can be prompted to select his or her interests 706 from a plurality of options. A user interface can present drill-down user-interface controls to enable the user to fine-tune their sub-interests within more general level of interests. For example, selecting sports can further segment into varying sport interests, such as, basketball, football, etc. Upon completion selecting interests 706, the user is grouped into each of the selected interests and then moves to homepage 707. Homepage 707 can include information in one or more of three categories—each supporting one another with regards to people 711, event 708, and deal/idea 709:
Deals/Ideas 709 can include site-generated deals or affiliate deals promoted on the site from other deal-a-day sites, coupons, promotions, and advertising—from local and/or national businesses.
Events 708 are either user or business created. The event can be categorized by Today, 2-3 days and Future.
People 711 can include individuals that are: a) currently on social networking system 799 and within the people pool 710 or b) selected the people pool 710 as a basic interest. Users can chose to IM, follow, invite to events, share information, photos, and other information with users 711.

People 711, Deals 709, and Events 708 can be matched through various matching algorithms 717 designed to match data fields, words, past behaviors, location, predictive future behavior, etc. People 711, Deals 709, and Events 708 can be geo-located 712, based on user preferences. The user has any of several outcomes 713 that can result from visiting each of the home pages:
Friends 714: The user can further establish existing friendships through information sharing, event participation or other social behaviors. The user may choose to integrate Events and Deals, but can also use the site and each category to maintain or establish friendships or a variety of purposes.
Events 715: The user has the option to post events or browse and participate in others' events. Businesses, can also post events.
Purchase 716: The user can choose to browse and purchase deals/ideas, coupons, promotions, and view advertising relating to the category (people, events, deals).

Any of defined and historical user behavior 718, data pulled from social sites 705, businesses site-generated deals, promos and advertising 719, affiliate referral deals 721 can be used by matching algorithms 717 in predictive modeling and matching for future categories.

Geo-location 720 of each category element can be used to enhance the overall user experience. For example, geo-location 720 can be used to significantly increase the matchability of events and deals. In some embodiments, events and deals can be matched within a 400 ft radius (versus zip code range when geo-location is not used).

Site elements are accessible through wireless exchanges 722, such as, for example, phone and tablets 723.

In some embodiments, a user creates an event and then has the ability to choose one or more of: deals, advertisements, and promos relevant to the event (e.g., as proposed by the site). In other embodiments, a user creates an event and then an algorithms predictive behavior is used to assign one or more of: deals, advertisements, and promos to the event based on one or more of: past behavior, location, and predicted future behavior.

Embodiments of the invention use intelligent specifications, algorithms and matching of defined data criteria to achieve a unique user experience.

Modules, algorithms, components, etc., depicted in computer architecture 700 can be connected to one another over (or be part of) a network, such as, for example, a Local Area Network (“LAN”), a Wide Area Network (“WAN”), and even the Internet. Accordingly, the modules, algorithms, components, etc., depicted in computer architecture 700 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

Embodiments of the invention integrate social, event, and deal networking elements with geo-location functionality. Integrating geo-location functionality with social, event and deal networking elements, provides opportunities for users to meet new people, share real world experiences through individual-created or business-created events. The provided opportunities can be further integrated with business-sponsored ads, promotions, or deal-a-day enhancements. In some embodiments, profile elements combined with interests and/or geographic location and geo-location settings are used to match users to marketing events or other people.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, the computer system including one or more processors and system memory, a method for matching a person to an activity, the method comprising:
accessing user profile information for the person, the user profile information for the person including interests, geographic location, and geo-location settings for the person, the geo-location settings indicating a specified distance from the person, the person desiring to be made aware activities of interest that are within the specified distance of the person;
accessing activity profile information for one or more activities, the activity profile information including an activity subject and geographic location for each of the one or more activities; and
identifying an activity, from among the one or more activities, as relevant to the person, the identified activity identified as being relevant to the person based on the activity being of interest to the person and the geographic location of the activity being within the specified distance of the geographic location of the person.

2. The method of claim 1, wherein identifying an event or a deal relevant to the person comprises identifying an event or deal relevant to the person based on one or more of: the person's past behavior, past purchase patterns, and predicted future behavior.

3. The method of claim 1, wherein accessing profile information for the person comprises accessing interests for the person that were selected from a drill-down menu of different interests.

4. The method of claim 1, wherein the activity is an event.

5. The method of claim 1, wherein the activity is a deal.

6. The method of claim 1, wherein accessing user profile information for the person comprises accessing interests of the person from the user profile information;
wherein accessing activity profile information for one or more activities comprises accessing a subject for each of the one or more activities; and
wherein identifying an activity, from among the one or more activities, as relevant to the person comprises determining that interests of the person and the subject of the activity are sufficient similar.

7. At a computer system, the computer system including one or more processors and system memory, a method for matching a person to another person, the method comprising:
accessing user profile information for the person, the user profile information for the person including interests, geographic location, and geo-location settings for the person, the geo-location settings indicating a specified distance from the person, the person desiring to be made aware other people of interest that are within the specified distance of the person;
accessing further user profile information for one or more other people, the further profile information including a geographic location for each of the one or more other people; and
identifying another person, from among the one or more other people, as being relevant to the person, the identified other person identified as being relevant based on the other person being of interest to the person and the geographic location of the other person being within the specified distance of the geographic location of the person.

8. The method as recited in claim 7, wherein accessing user profile information for the person comprises accessing user profile information for the person from a social networking site.

9. The method of claim 7, wherein identifying another person, from among the one or more other people, as being relevant to the person comprises identifying another person, from among the one or more other people, as being relevant to the person based on one or more of: the person's past behavior, past purchase patterns, and predicted future behavior.

10. The method as recited in claim 7, wherein accessing user profile information for the person comprises accessing interests of the person from the user profile information;
wherein accessing further user profile information for one or more other people comprises accessing interests of the one or more other people from the further user profile information; and
identifying another person, from among the one or more other people, as being relevant to the person comprises determining that interests of the person and the interests of the other person are sufficiently similar.

11. At a computer system, the computer system including one or more processors and system memory, a method for assigning a marketing activity to an event, the method comprising:
detecting that a user has created an event, the user being a member of a social network;
accessing event profile information for the event, the event profile information including an event subject, geographic location, and geo-location settings associated with the event, the user desires for marketing activities relevant to the event and that are within the specified distance of the geographic location of the event to be assigned to the event;
accessing marketing profile information for one or more marketing activities, the marketing profile information including a marketing subject and a geographic location for each of the one or more marketing activities;
identifying a marketing activity, from among the one or more marketing activities as relevant to the event, the identified marketing activity identified as being relevant to the event based on the marketing subject being relevant to the event subject and the geographic location of the marketing activity being with the specified distance of the event.

12. The method of claim 11, wherein accessing event profile information for the event comprises accessing event profile information for the event from a social networking system; and
wherein accessing marketing profile information for one or more marketing activities comprises accessing marketing profile information for one or more marketing activities from the social networking system

13. The method of claim 12, wherein identifying marketing activity, from among the one or more marketing activities as relevant to the event comprises identifying one of: a deal, an advertisement, or promo as relevant to the event.

14. The method of claim 13, wherein identifying one of: a deal, an advertisement, or promo as relevant to the event comprises identifying one of: a deal, an advertisement, or promo relevant to the event based on past behavior and predicted future behavior of one or more users of the social networking system.
